(19) United States
(12) Patent Application Publication
(10) Pub. No.: US 2012/0294669 A1
(43) Pub. Date: Nov. 22, 2012

(54) BINDER

(75) Inventor: Adam Wrigley, New York, NY (US)

(73) Assignee: Staples The Office Superstore, LLC, Framingham, MA (US)

(21) Appl. No.: 13/438,044

(22) Filed: Apr. 3, 2012

Related U.S. Application Data
(60) Provisional application No. 61/486,462, filed on May 16, 2011.

(51) Int. Cl. B42F 13/20

(52) U.S. Cl. 402/31

(57) ABSTRACT

A binder for retaining an item is provided. The binder includes a first panel, a second panel and a spine coupling the first panel to the second panel. The binder also includes a first hinge assembly connecting the first panel to the spine, where the first hinge assembly includes a first hinge and a second hinge, and the second hinge is less flexible than the first hinge.

### RELATED APPLICATIONS

This Application claims priority under 35 U.S.C. § 119(e) to U.S. Provisional Application Ser. No. 61/486,462, entitled “BINDER” filed on May 16, 2011, which is herein incorporated by reference in its entirety.

### BACKGROUND OF INVENTION

Aspects of the invention relate to binders for holding articles, such as paper.

### BACKGROUND

Binders are employed to hold articles, typically loose-leaf papers, documents, and the like. Labels and pockets may be viewable from the outside of the spine or cover(s) in order to identify the contents of the binder to a user.

### SUMMARY

In one illustrative embodiment, a binder for retaining an item is provided. The binder includes a first panel, a second panel and a spine coupling the first panel to the second panel. The binder also includes a first hinge assembly connecting the first panel to the spine, where the first hinge assembly includes a first hinge and a second hinge, and the second hinge is less flexible than the first hinge.

In another illustrative embodiment, a binder for retaining an item is provided. The binder includes a first panel, a second panel, and a spine coupling the first panel to the second panel. The binder has an outer pocket coupled to one of the first and second panels. The binder may also include an inner pocket coupled to one of the first and second panels.

Various embodiments of the present invention provide certain advantages. Not all embodiments of the invention share the same advantages and those that do may not share them under all circumstances.

Further features and advantages of the present invention, as well as the structure of various embodiments that incorporate aspects of the invention are described in detail below with reference to the accompanying drawings.

### BRIEF DESCRIPTION OF DRAWINGS

The foregoing and other objects and advantages of the invention will be appreciated more fully from the following drawings, wherein like reference characters designate like features, in which:

FIGS. 1A-1B are perspective views of the binder according to one embodiment;

FIG. 2 is a perspective view of the binder according to one embodiment in an open position;

FIGS. 3A-3B are side views of a portion of the binder according to one embodiment;

FIGS. 4-9 illustrate various perspective views of a binder according to another embodiment;

FIG. 10 is a top view of a pocket on the binder shown in FIG. 6;

FIGS. 11-14 illustrate various perspective views of a binder according to yet another embodiment;

FIGS. 15A-15B are top views of portions of the pocket on the binder shown in FIG. 11;

FIG. 15C is a perspective view of the pocket on the binder shown in FIG. 11;

FIGS. 16-19 are various perspective views of a binder according to another embodiment; and

FIG. 20 is a perspective view of a binder according to yet another embodiment.

### DETAILED DESCRIPTION OF INVENTION

The present invention is directed to a unique binder for holding articles, such as loose-leaf papers, documents, and the like. Aspects of the present invention are directed to a binder with an expandable spine which is configured to expand into a thicker configuration for holding more papers. Further aspects of the present invention are directed to a binder with a unique outer pocket assembly. Other aspects of the present invention are directed to a binder which includes a unique inner pocket assembly.

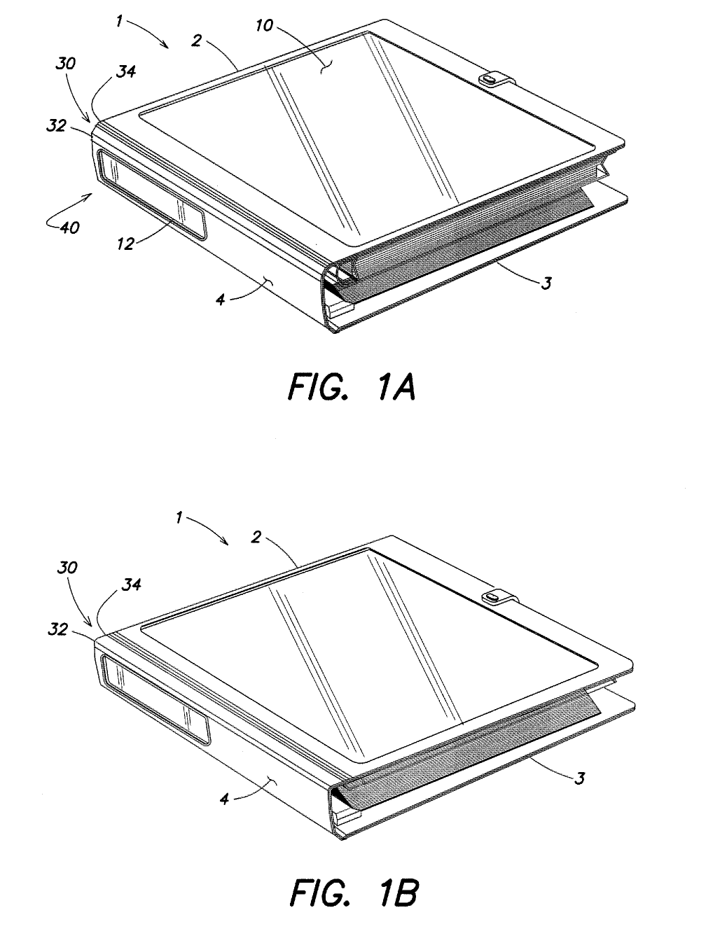

Turning to FIGS. 1-3, a binder 1 according to one illustrative embodiment is shown. The binder 1 comprises a front panel 2, a back panel 3, and a spine 4. The spine 4 is pivotably connected to both the front and back panels 2, 3.

The binder 1 is configured to hold papers, such as loose leaf 8½ by 11 papers, although other sizes may be used. To accomplish this, the binder 1 may include one or more fasteners, such as a set of rings 20, attached to the front panel 2, back panel 3, or to the spine 4. In this illustrative embodiment, the rings 20 are attached to the spine 4. The rings 20 are configured to correspond to the holes in the loose leaf paper(s) and may be of split ring configuration with an operating mechanism that opens the rings. Thus, the rings can be opened to add or remove papers, and closed to retain the papers, as is known in the art. Some examples of binders are described in U.S. Pat. No. 7,399,136, and U.S. Pat. No. 7,717,639, both of which are hereby incorporated by reference in their entirety, although it should be appreciated that other covers, to hinges, and ring configurations may be employed. It should be recognized that it is also contemplated that the binder 1 may include other types of fasteners configured to hold paper, as the invention is not limited to a set of rings 20.

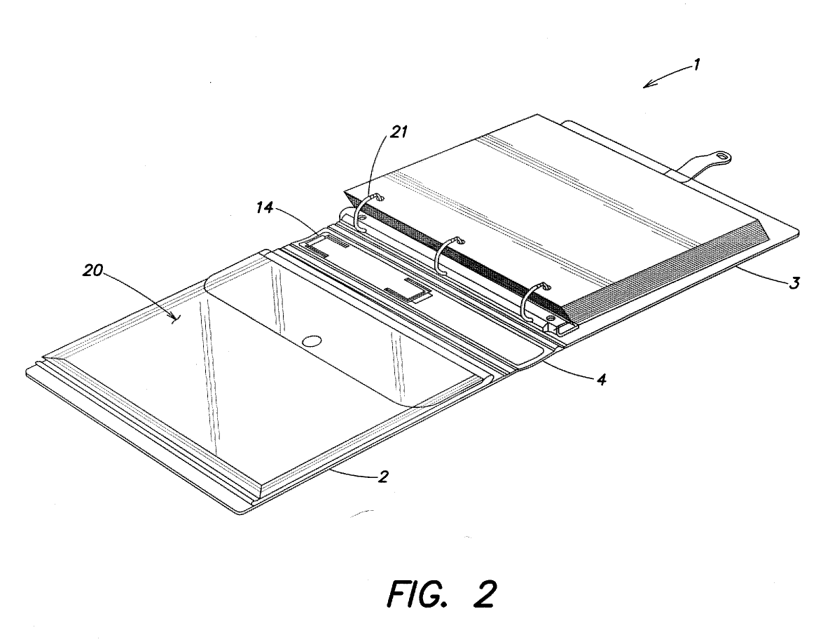

As set forth in greater detail below, the binder 1 may include an outer pocket 10 on one or both of the front or back panels 3, 4 and the contents of the outer pocket 10 may be visible when the binder is in a closed position (shown in FIGS. 1A-1B). As shown in FIG. 2, the binder may also include an inner pocket 20 on the front or back panels 3, 4, and the contents of the inner pocket 20 may be visible when the binder 1 is in an open position. As also shown in FIGS. 1-2, the binder 1 may include a spine label assembly 14, the contents of which may be visible through a window 12 in the spine 4. Further details of the spine label assembly 14 are disclosed in U.S. Pat. No. 7,717,639.

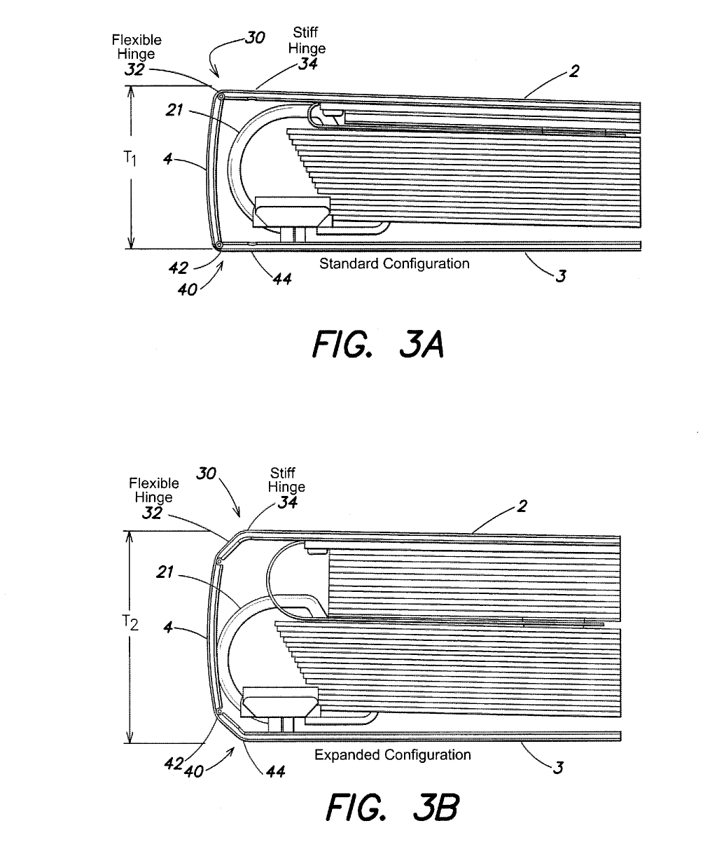

As mentioned above, aspects of the present invention are directed to a binder 1 with an expandable spine 4 configured to expand into a thicker configuration for holding more papers. As shown in FIGS. 1 and 3, the binder 1 may include a first hinge assembly 30 connecting the front panel 2 to the spine 4, and the first hinge assembly 30 includes a first hinge 32 and a second hinge 34. As shown in FIGS. 1B and 3A, in a first configuration, the first hinge 32 is bent and the second hinge 34 remains substantially planar such that the spine 4 has a thickness T₁. As shown in FIGS. 1A and 3B, in a second expanded configuration, both the first and second hinges 32, 34 are bent such that the spine 4 has a thickness T₂. As shown in FIGS. 3A-3B, the spine thickness T₂ in the second expanded configuration is greater than the spine thickness T₁ in the first configuration and can thus accommodate a thicker stack of papers within the binder 1.

It is contemplated that the first hinge 32 is configured to bend when the binder moves from an open position (shown in FIG. 2) to a closed position (shown in FIGS. 1 and 3). In one embodiment, the second hinge 34 is configured to flex or bend when paper is added to the binder and a thicker spine 4 is needed to hold the volume of paper. As illustrated, in one embodiment, the hinge assembly 30 is a double hinge where the first hinge 32 is positioned proximate the spine 4 and the second hinge 34 is positioned proximate the first panel 2.

As shown in FIGS. 1 and 3, the binder 1 may also include a second hinge assembly 40 connecting the back panel 3 to the spine 4, and the second hinge assembly 30 includes a first hinge 42 and a second hinge 44. As shown in FIGS. 1B and 3A, in a first configuration, the first to hinge 42 is bent and the second hinge 44 remains substantially planar such that the spine 4 has a thickness T₁. As shown in FIGS. 1A and 3B, in a second expanded configuration, both the first and second hinges 42, 44 are bent such that the spine 4 has a thickness T₂ to accommodate a thicker stack of papers.

In one embodiment, the second hinge 34, 44 is less flexible than the first hinge 32, 42. In this respect, when the binder 1 moves from its open position to its closed position, the more flexible first hinge 32, 42 will be configured to bend before the second hinge 34, 44. Thereafter, when a larger spine 4 is needed to accommodate the contents within the binder 1, the second hinge 34, 44 bends upon the application of a larger force.

It is contemplated that there are a variety of ways in which the second hinge 34, 44 is configured to be less flexible than the first hinge 32, 42. In one embodiment, the first and second hinges are made of the same material, and the thickness of the second hinge 34, 44 is greater than the thickness of the first hinge 32, 42. The first hinge 32, 42 may be more flexible due to its smaller thickness. It is also contemplated that the first and second hinges are made of different materials and the first hinge material may be more flexible than the second hinge material.

One of ordinary skill in the art would appreciate that a variety of materials may be used to form the hinge assembly 30, 40 such as, but not limited to plastic materials, such as a thermoplastic elastomer (TPE). In one embodiment, the first hinge 32, 42 is integrally molded with the second hinge 34, 44. It is also contemplated that, in one embodiment, the first hinge assembly 30 is integrally molded with the front panel 2 and the spine 4, and the second hinge assembly 40 is integrally molded with the back panel 3 and the spine 4.

The above-mentioned figures illustrate a double hinge assembly. However, the invention is not so limited. It is also contemplated that a hinge assembly 30, 40 may include more than two hinges. For example, in one embodiment, the hinge assembly 30 may include a third hinge, and in another embodiment, the hinge assembly 30 may include a third hinge and a fourth hinge. It should be appreciated that the present invention contemplates the use of a multiple hinges to vary the thickness of the spine 4. Furthermore, the third and/or fourth hinge may be less flexible than the first hinge and/or the second hinge. It is also contemplated that the third and/or fourth hinge may have a flexibility that is substantially the same as the first hinge and/or the second hinge.

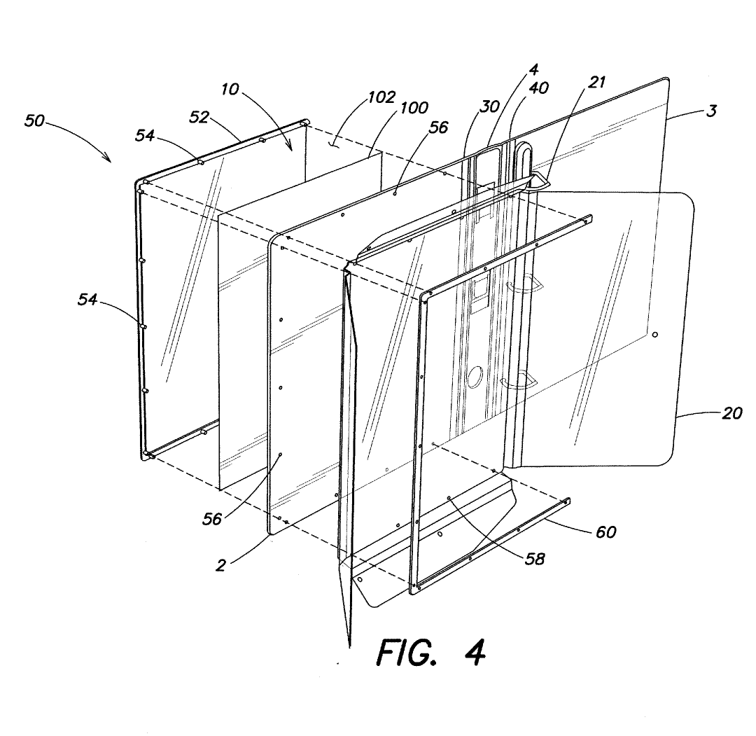

Turning now to FIGS. 4-10, one embodiment of a binder 50 is shown in greater detail. Similar to the above described binder 1, this binder 50 has a front panel 2, a back panel 3, and a spine 4 pivotably connected to both the front and back panels 2, 3 with the above described first and second hinge assemblies 30, 40. As set forth in greater detail below, the binder 50 also has an outer pocket 10 on a first surface of the front panel 3 and an inner pocket 20 on an opposite surface of the front panel 3.

In this illustrative embodiment, the outer pocket 10 is formed between a cover panel 52 and the front panel 2 and is configured to receive an article 100, such as paper. One or more sides of the cover panel 52 are secured to the front panel 2 to form a pocket therebetween. One of ordinary skill in the art would recognize that there are a variety of ways in which the cover panel 52 may be secured to the front panel 2, including, but not limited to adhesives, welding, molding, and mechanical fasteners. In one illustrative embodiment, a plurality of bosses 54 mate with a plurality of holes 56. In this particular embodiment, the bosses 54 are positioned on the cover panel 52 and the holes are positioned on the front panel 2. The bosses 54 may be heat staked to secure the bosses 54 within the holes 56.

In one embodiment, the cover panel 52 is secured to the front panel 2 along three out of four of its sides, and the fourth non-secured side forms an opening 102 for the article 100 to be inserted into and/or removed from the pocket 10. As shown, the pocket 10 may be configured such that the opening 102 extends along the side of the binder, and may for example extend substantially along the length of the binder adjacent the spine 4. This is in contrast to conventional binders having an outer pocket where the pocket opening extends along a top edge.

In this illustrative embodiment, the inner pocket 20 is positioned on an inside surface of the front panel 2. As shown, the inner pocket may include holes 58 that are configured to align with the holes 56 in the front panel 2 such that the bosses 54 mate with the holes 58 on the pocket 20 to secure the pocket 20 to the binder 50. As mentioned above, the invention also contemplates other ways to secure the pockets 10, 20 to the panel 2, as the invention is not so limited.

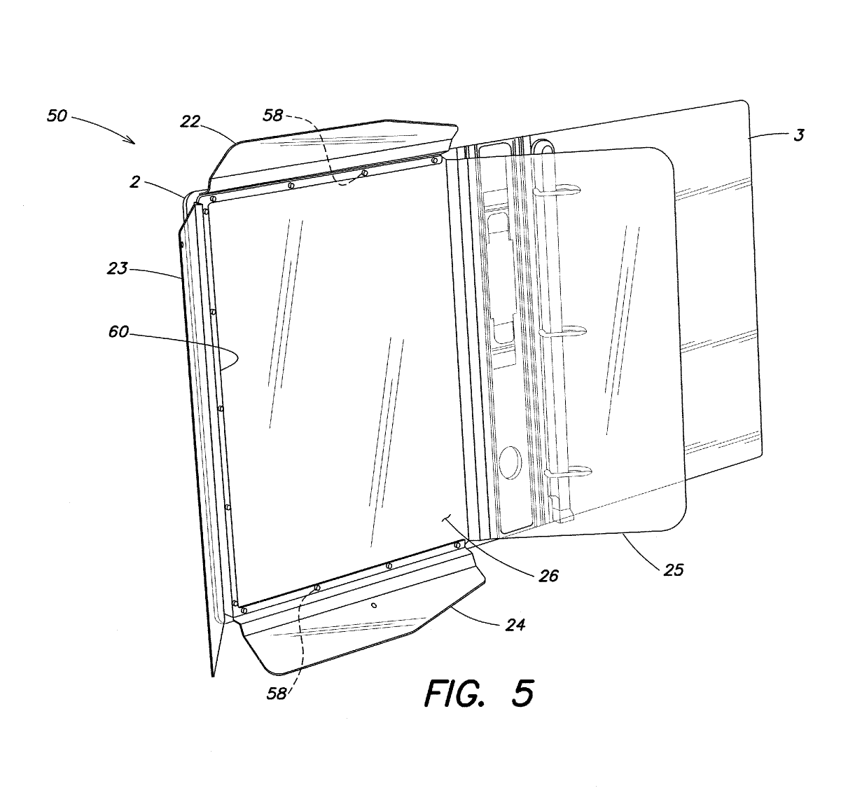

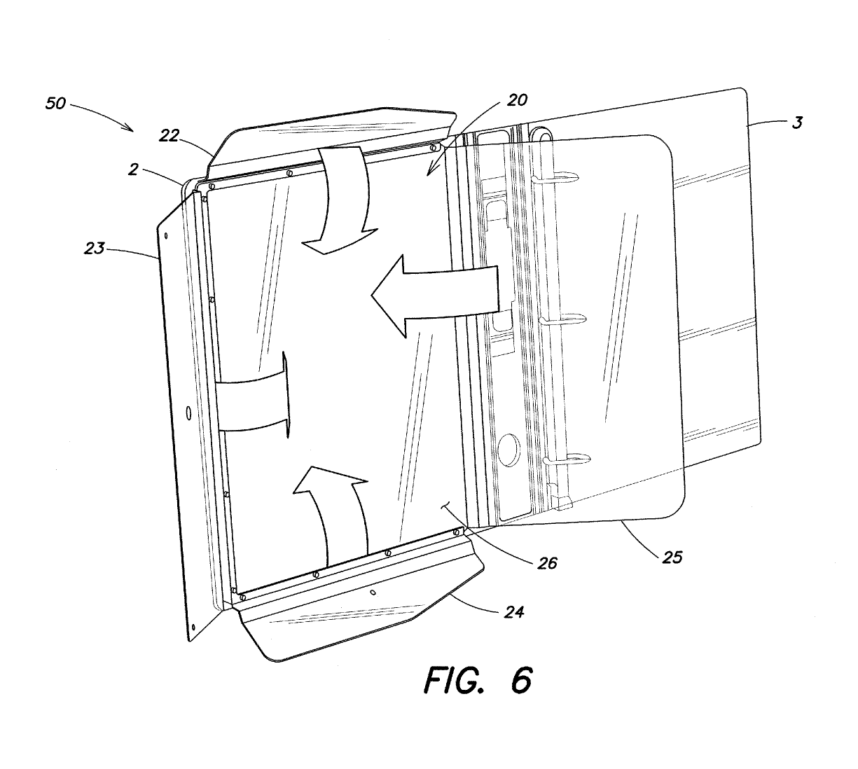

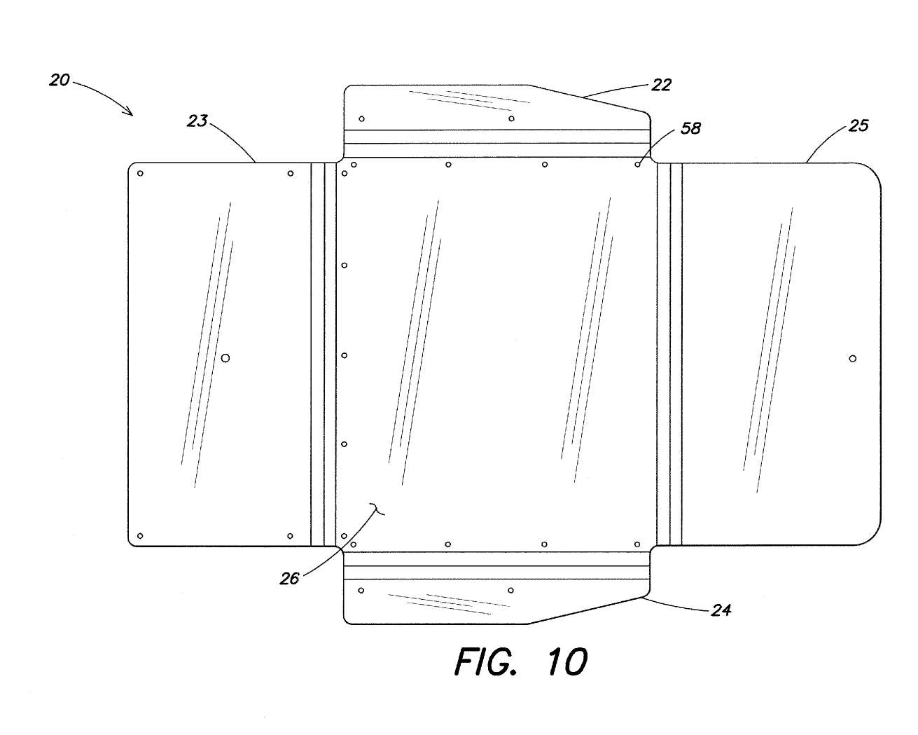

As shown in FIG. 4-10, the inner pocket 20 may include a plurality of panels 22, 23, 24, 25, 26 which may fold together to form a pocket. As shown in FIG. 10, it is contemplated that these plurality of panels 22, 23, 24, 25, 26 are formed from one piece of material. However, as set forth in more detail below, other pocket constructions are also contemplated. As shown in FIGS. 5-6, top and bottom panels 22, 24 and side panel 23 may each be folded against back to panel 26 to form an envelope-like pocket 20. The inner pocket may be gusseted to increase the storage capacity within the pocket 20. As shown, the top and bottom panels 22, 24 and the side panel 23 may also include a plurality of holes 58 configured to mate with the bosses 56 to secure the pocket 20 to the binder 50. Furthermore, a frame 60 may be provided to support the pocket 20 and also to cover or cap the heat staked bosses 56. In this particular embodiment, the frame 60 is substantially C-shaped and is secured to the back panel 26 of the pocket 20 such that the frame 60 is covered by the top, bottom and side panels 22, 23, 24 of the pocket 20. The side panel or flap 25 may be provided to cover the opening into the inner pocket 20.

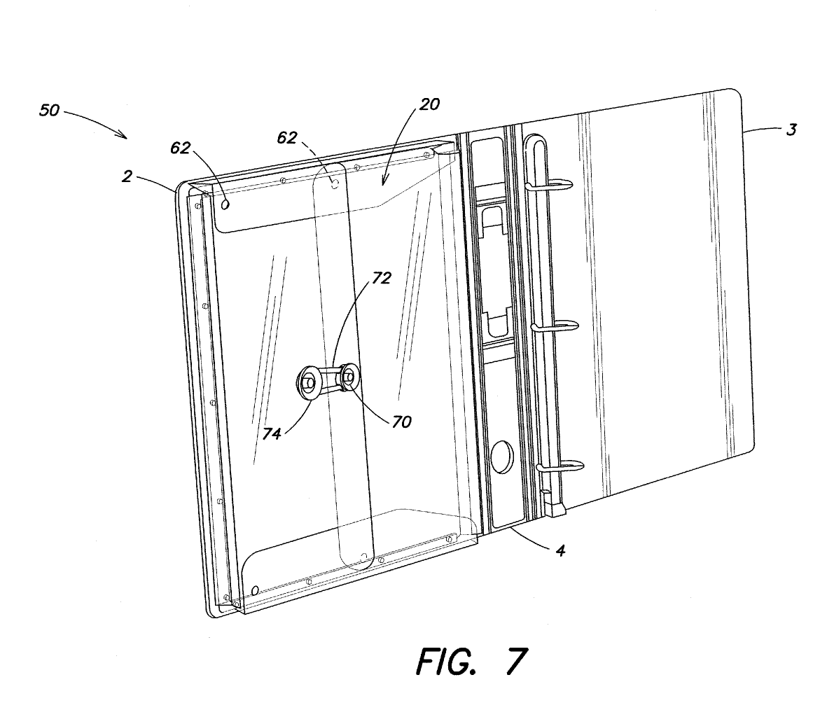

As shown in FIG. 7, the flap 25 may include a fastener which is coupleable with the side panel 23 to secure the flap 25 in a closed position. For example, in one embodiment, the flap 25 includes a spool 70 with a cord 72 which is configured to wrap around the spool 70 and an adjacent spool 74 positioned on the side panel 23. It is contemplated that the cord 72 may be made of an elastic stretchable material to accommodate larger stacks of paper, and the like, placed within the inner pocket 20. As shown in FIG. 7, one or more fasteners, such as rivets 62 may be provided to secure the pocket panels 22-26 to each other.

In this particular embodiment, the outer pocket 10 and the inner pocket 20 both extend substantially along the length and width of the front panel 2. In another embodiment, the outer pocket 10 and/or the inner pocket 20 extend only partially along the length and/or width of the front panel, as the invention is not so limited. Furthermore, although the outer pocket 10 is substantially the same size as the inner pocket 20, other shapes, sizes and configurations are also contemplated. It should be appreciated that an envelope-style pocket may be used as the outer pocket 10 and that the inner pocket 20 may simply include a cover panel secured to one of the panels 2, 3 of the binder, as the invention contemplates a variety of pocket configurations.

In one embodiment, the cover panel 54 is made from a transparent material such that the contents of the outer pocket 10 are visible when the binder is in a closed position. In one embodiment, the cover panel is made from a substantially rigid material, and may, for example, be made of a rigid molded plastic. In one embodiment, the inner pocket 20 may also be made from a transparent material such that the contents of the inner pocket 20 may be visible when the binder 1 is in an open position. For example, in one embodiment, the inner pocket 20 is made of a substantially flexible material, such as polypropylene (PP) or polyethylene (PE). The invention also contemplates the use of other non-transparent materials, as the invention is not so limited.

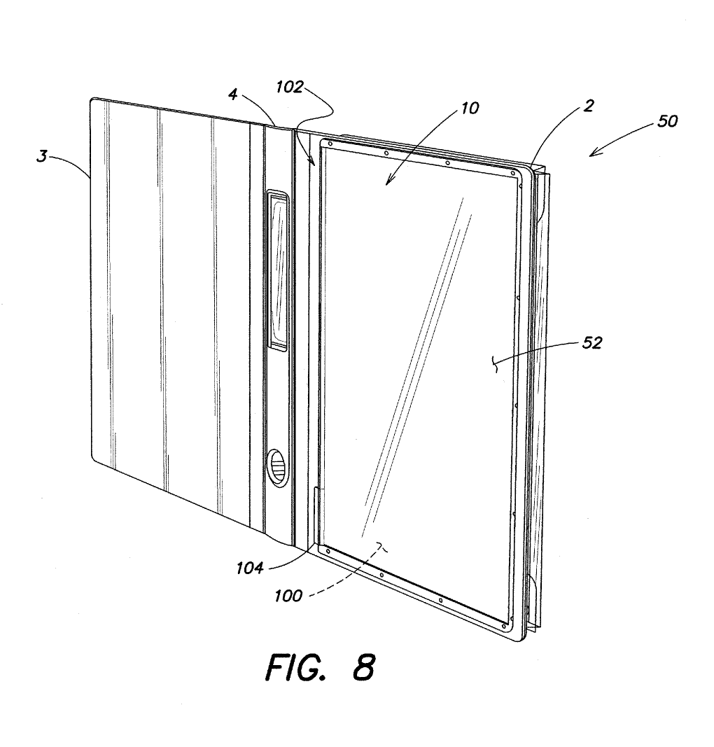

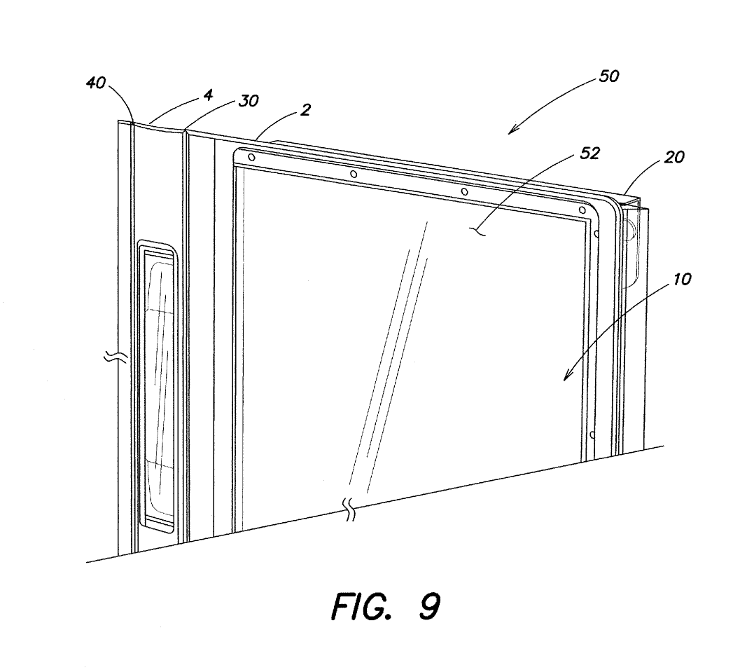

As shown in FIGS. 8-9, in one embodiment, the cover panel 52 is recessed within an inset portion of the front panel 2, such that the cover panel 52 is substantially flush with the outer perimeter of the front panel 2. As shown in FIG. 8, an article 100, such as a piece of paper may be inserted into the outer pocket 10 through the opening 102. An article 100 may be included with the binder to illustrate this pocket feature. The article 100 may include one or more tabs 104 configured to extend out of the pocket 10 through the opening 102 so that a user can easily see the pocket feature and so that a user can readily pull the article 100 out of the pocket 10.

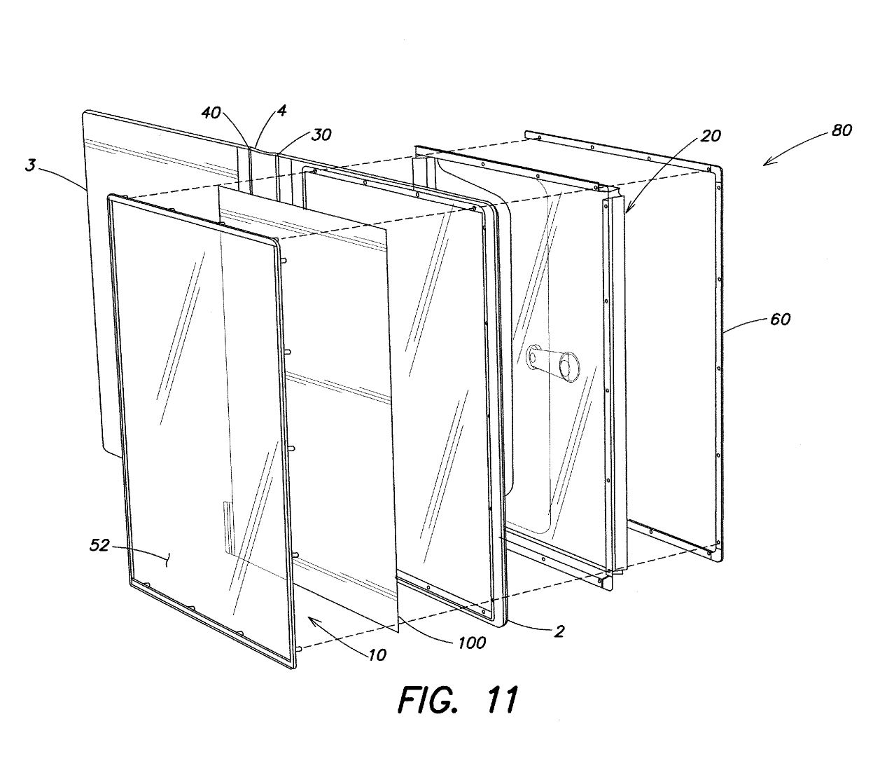

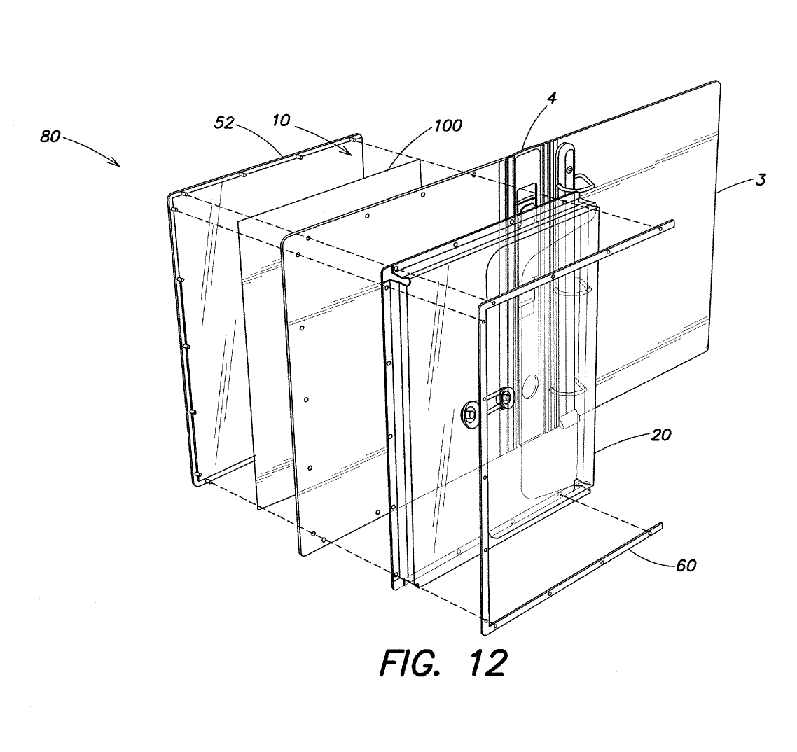

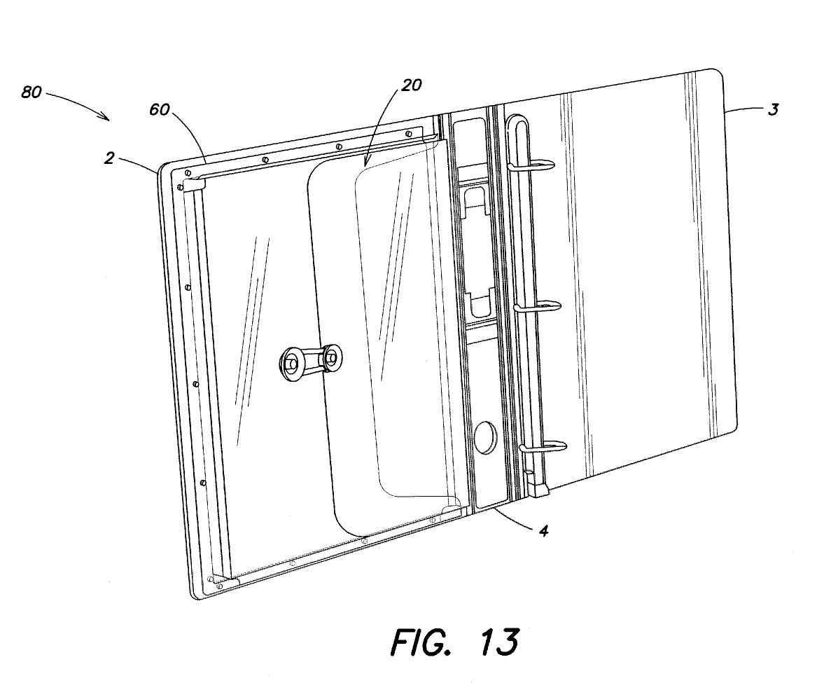

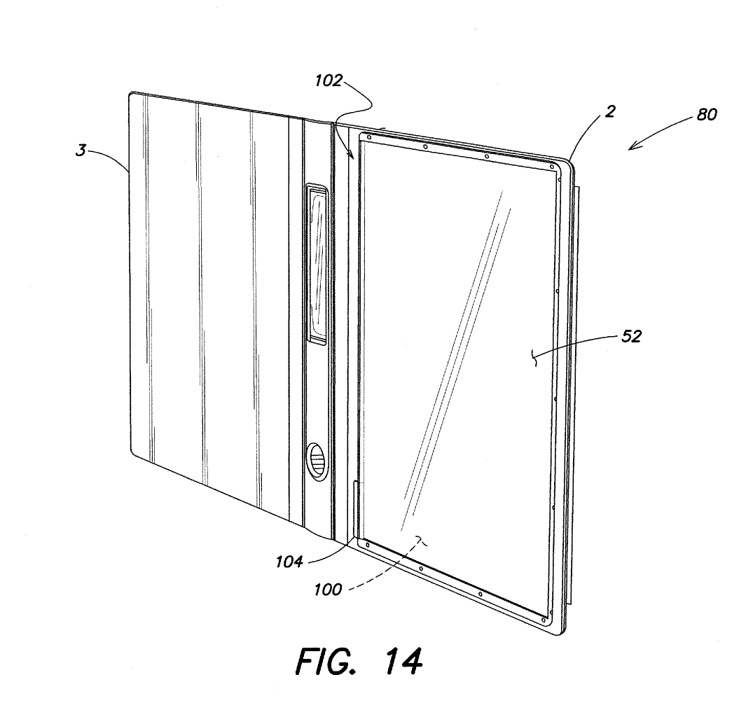

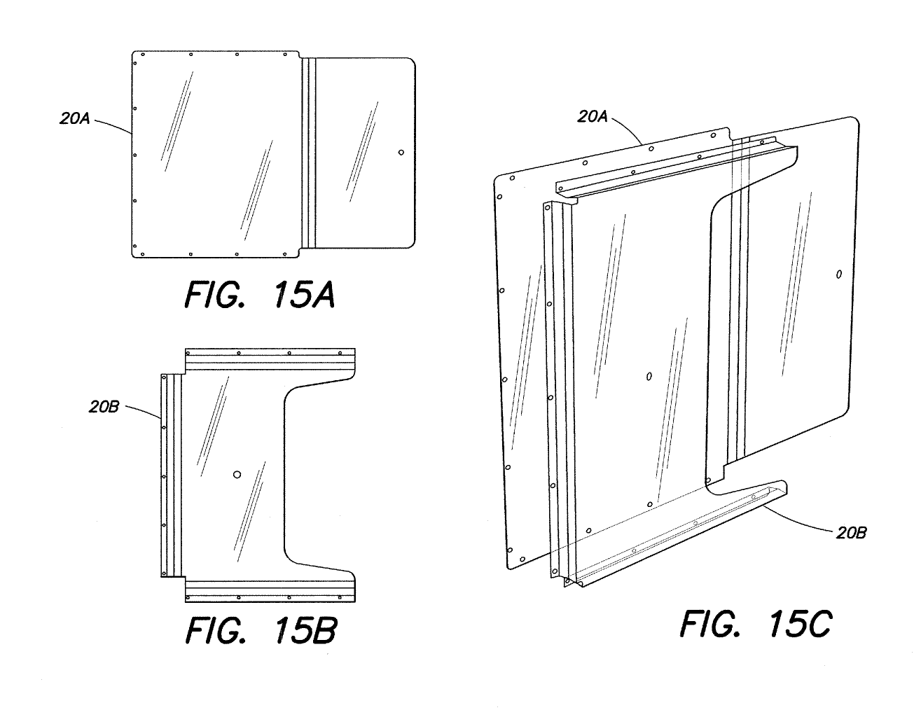

Turning now to FIGS. 11-15 another embodiment of a binder 80 is shown in greater detail. Similar to the above described binders 1, 50, this binder 80 has a front panel 2, a back panel 3, and a spine 4 pivotably connected to both the front and back panels 2, 3 with the above described first and second hinge assemblies 30, 40. The binder 80 has an outer pocket 10 on the front panel 3 and an inner pocket 20 on the front panel 3. The outer pocket 10 may be formed in substantially the same manner as the embodiment described above and shown in FIGS. 4-9. As shown in FIGS. 15A-15C, the inner pocket 20 is formed of two sections which are coupled together. In particular, a first pocket section 20A forms the back of the pocket and a second pocket section 20B forms the front of the pocket. As illustrated, the pocket sections 20A, 20B have a plurality of holes which are configured to mate with the bosses 54 to both secure the pocket sections 20A, 20B together and also to secure the pocket 20 to the binder panel 2. It should be recognized that the invention also contemplates other known ways to couple the pocket 20 to the panel 2, as the invention is not so limited.

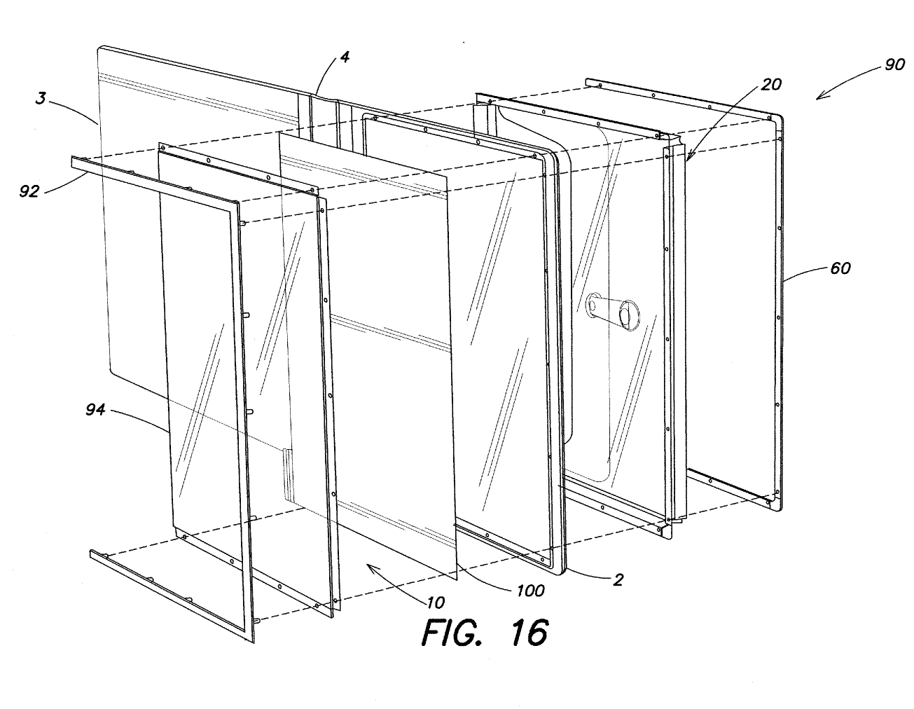

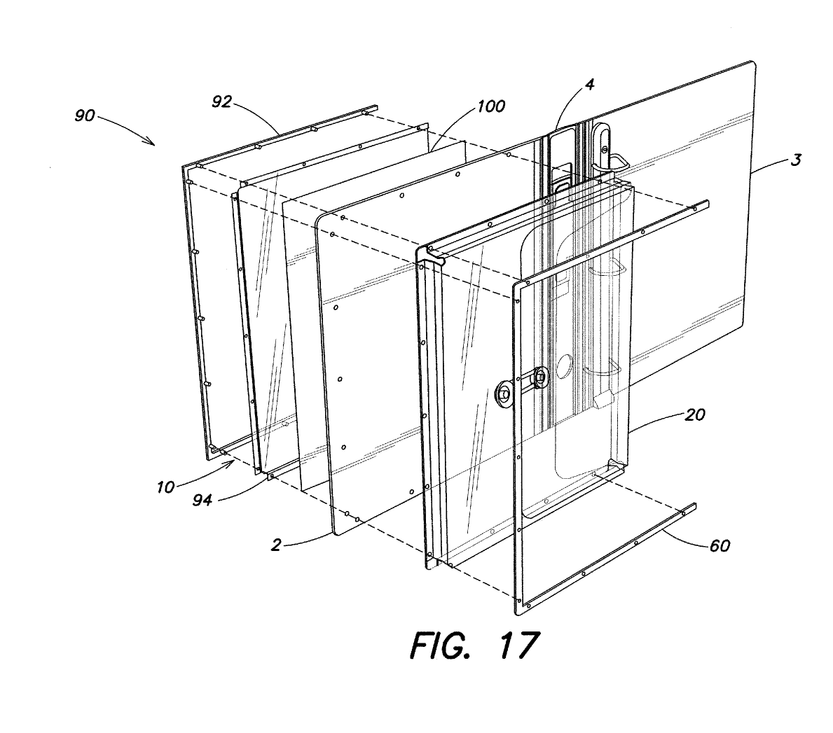

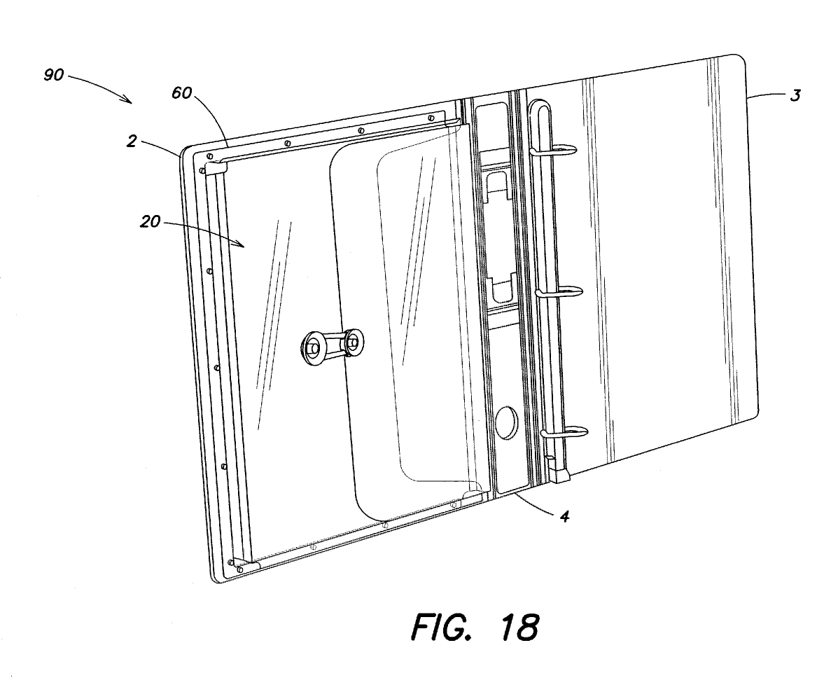

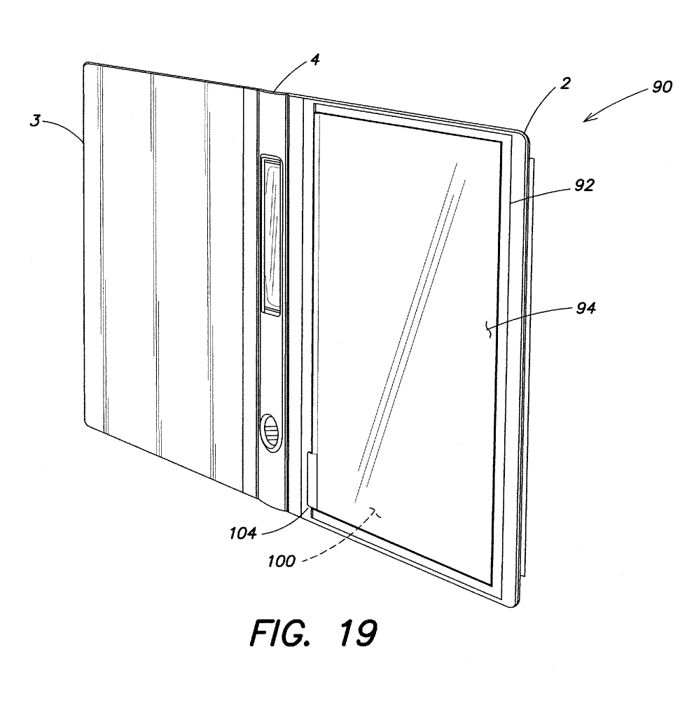

FIGS. 16-19 illustrate yet another embodiment of a binder 90. Similarly, this binder 90 has a front panel 2, a back panel 3, and a spine 4 with first and second hinge assemblies 30, 40. The binder 90 also has an outer pocket 10 on the front panel 3 and an inner pocket 20 on the front panel 3. The inner pocket 20 may be formed in substantially the same manner as one of the above described embodiments. In this embodiment, the outer pocket 10 is formed between a cover panel 94 and the front panel 2 and is configured to receive an article 100, such as paper. One or more sides of the cover panel 94 are secured to the front panel 2 to form a pocket therebetween. One of ordinary skill in the art would recognize that there are a variety of ways in which the cover panel 94 may be secured to the front panel 2, including, but not limited to adhesives, welding, molding, and mechanical fasteners. In one illustrative embodiment, a frame 92 is provided to secure the cover panel 94 to the panel 2. A plurality of bosses 54 on the frame to 92 mate with a plurality of holes 56 on the cover panel 94 and the panel 2. As mentioned above, the bosses 54 may be heat staked to secure the bosses 54 within the holes 56. In one embodiment, the cover panel 94 is secured to the front panel 2 along three out of four sides, and the fourth non-secured side forms an opening 102 for the article 100 to be inserted into and/or removed from the pocket 10. The pocket 10 may be configured such that the opening 102 extends along the side of the binder, and may for example extend substantially along the length of the binder adjacent the spine 4.

The cover panel 94 may be made from a transparent material such that the contents of the outer pocket 10 are visible when the binder is in a closed position. In one embodiment, the cover panel is made from a substantially flexible material, such as polypropylene (PP) or polyethylene (PE). When the cover panel 94 is made of a more flexible material, the frame 92 may be made of a more rigid material and may help to secure the cover panel 94 to the binder panel 2. However, it is also contemplated that the cover panel 94 is made from a substantially rigid material, and may, for example, be made of a rigid molded plastic.

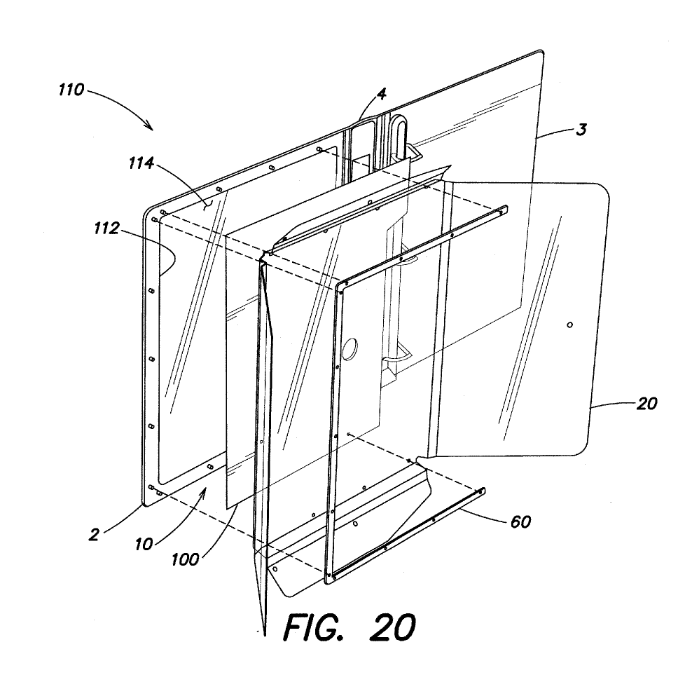

Turning now to FIG. 20, another embodiment of a binder 110 is shown in greater detail. Similar to the above described binders, this binder 110 has a front panel 2, a back panel 3, and a spine 4 with the above described first and second hinge assemblies 30, 40. The binder 110 also has an outer pocket 10 on the front panel 3 and an inner pocket 20 on the front panel 3. The inner pocket 20 may be formed in substantially the same manner as one of the above described embodiments.

In this embodiment, the binder panel 2 has a cutout 112 and a cover panel 114 is positioned within the cutout 112 to form an outer pocket 10 configured to receive an article 100, such as paper. In one embodiment, the cover panel 114 forms a window in the front panel 2 and the cover panel 114 is co-molded to the panel 2. In another embodiment, the cover panel 114 is over-molded to the panel 2. One or more sides of the cover panel 114 are secured to the front panel 2 to form a pocket. In one embodiment, the cover panel 114 is secured to the front panel 2 along three out of four sides, and the fourth non-secured side forms an opening 102 for the article 100 to be inserted into and/or removed from the pocket 10. As shown, the pocket 10 may be configured such that the opening 102 extends along the side of the binder, and may for example extend substantially along the length of the binder adjacent the spine 4. It is contemplated that the pocket 10 may be formed between the panel 2 and the cover panel 114. It is also contemplated that the pocket 10 may be formed behind the cover panel 114, such that the to pocket 10 is positioned between the cover panel 114 and the pocket 20. As shown, the panel 2 may include bosses configured to mate with holes on the inner pocket 20 to secure the inner pocket 20 to the binder panel 2.

It should be appreciated that various embodiments of the present invention may be formed with one or more of the above-described features. The above aspects and features of the invention may be employed in any suitable combination as the present invention is not limited in this respect. It should also be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one drawing figure, and/or may also encompass embodiments combining components illustrated in multiple different drawing figures.

It should be understood that the foregoing description of various embodiments of the invention are intended merely to be illustrative thereof and that other embodiments, modifications, and equivalents of the invention are within the scope of the invention recited in the claims appended hereto.

What is claimed is:

1. A binder for retaining an item, comprising:
a first panel;
a second panel;
a spine coupling the first panel to the second panel; and
a first hinge assembly connecting the first panel to the spine, wherein the first hinge assembly includes at least a first hinge and a second hinge, and wherein the second hinge is less flexible than the first hinge.

2. The binder of claim 1, wherein the first hinge assembly is configured such that the first hinge is positioned proximate the spine and the second hinge is positioned proximate the first panel.

3. The binder of claim 1, wherein the first hinge has a first thickness and the second hinge has a second thickness, wherein the second thickness is greater than the first thickness.

4. The binder of claim 1, wherein the first hinge is made from a first material and the second hinge is made from a second different material.

5. The binder of claim 1, wherein the first and second hinges are made from the same material.

6. The binder of claim 1, wherein the first hinge is integrally molded with the second hinge.

7. The binder of claim 1, wherein the first hinge assembly is integrally molded with the first panel and the spine.

8. The binder of claim 1, further comprising a second hinge assembly connecting the second panel to the spine, wherein the second hinge assembly includes a first hinge and a second hinge, and wherein the second hinge is less flexible than the first hinge.

9. The binder of claim 8, wherein the second hinge assembly is configured such that the first hinge is positioned proximate the spine and the second hinge is positioned proximate the second panel.

10. The binder of claim 8, wherein the first hinge has a first thickness and the second hinge has a second thickness, wherein the second thickness is greater than the first thickness.

11. The binder of claim 8, wherein the first hinge is made from a first material and the second hinge is made from a second different material.

12. The binder of claim 8, wherein the first and second hinges are made from the same material.

13. The binder of claim 8, wherein the first hinge is integrally molded with the second hinge.

14. The binder of claim 8, wherein the second hinge assembly is integrally molded with the second panel and the spine.

15. The binder of claim 1, wherein the first hinge assembly includes a third hinge positioned between the first hinge and the second hinge.

16. The binder of claim 15, wherein the first hinge assembly includes a fourth hinge positioned between the first hinge and the second hinge.
